(19) United States
(12) Patent Application Publication
(10) Pub. No.: US 2026/0219896 A1
(43) Pub. Date: Jul. 30, 2026

(54) SYSTEMS AND METHODS FOR SMART SETTING CONFIGURATION

(71) Applicant: Meta Platforms, Inc., Menlo Park, CA (US)

(72) Inventors: Marek Matejka, Long Island City, NY (US); Wesley Kazue Kiyohara, Whittier, CA (US); Nicholas Melhado, Brooklyn, NY (US); Nischal Patel, Hillsborough, NJ (US); Arpit Shah, Edison, NJ (US); Batya Zamansky, Urbana, IL (US)

(73) Assignee: Meta Platforms, Inc., Menlo Park, CA (US)

(21) Appl. No.: 19/459,751

(22) Filed: Jan. 26, 2026

Related U.S. Application Data
(60) Provisional application No. 63/750,382, filed on Jan. 28, 2025.

(51) Int. Cl. G06F 9/445; G06Q 10/44

(52) U.S. Cl. CPC G06F 9/44505; G06Q 10/44

(57) ABSTRACT

Systems and methods are disclosed for smart setting configurations. Example methods may include ingesting a plurality of items of data, wherein each item of data is retrieved from a data source within a plurality of data sources associated with a user account on a social media platform, for each item of data, providing the item of data as input to a distinct machine learning algorithm in a plurality of contextual machine learning algorithms, and providing output of the plurality of contextual machine learning algorithms to an additional machine learning algorithm as input. Some methods may include formulating a setting configuration for the user account on the social media platform based at least in part on output of the additional machine learning algorithm, and generating a recommendation comprising the setting configuration to a user that operates the user account.

### CROSS-REFERENCE TO RELATED APPLICATION

This application claims the benefit of US application no. 63/750,382, filed January 28, 2025, the entirety of which is hereby incorporated by reference.

### BACKGROUND

Users may have a number of settings options with various mobile applications and/or across other user platforms. However, repetitive setting configuration may not only be time consuming, but may lead to discrepancies and/or unintended changes in settings across various applications. Accordingly, systems and methods for smart setting configuration may be desired.

### BRIEF DESCRIPTION OF DRAWINGS AND APPENDICES

The accompanying figures and appendices illustrate a number of exemplary embodiments and are a part of the specification. Together with the following description, these figures and appendices demonstrate and explain various principles of the present disclosure.

FIG. 1 is a flow diagram of an exemplary method for smart setting configuration.

FIG. 2 is a block diagram of an exemplary system for smart setting configuration on a single platform.

FIG. 3 is a block diagram of an exemplary system for smart setting configuration across multiple platforms.

Throughout the figures and appendices, identical reference characters and descriptions indicate similar, but not necessarily identical, elements. While the exemplary embodiments described herein are susceptible to various modifications and alternative forms, specific embodiments have been shown by way of example in the figures and appendices and will be described in detail herein. However, the exemplary embodiments described herein are not intended to be limited to the particular forms disclosed. Rather, the present disclosure covers all modifications, equivalents, and alternatives falling within this disclosure.

### DETAILED DESCRIPTION

The way people share content online has evolved significantly over the years. With the rise of social media platforms, users are now able to share their thoughts, experiences, and creations with a global audience. However, the process of sharing content can be overwhelming, especially when it comes to managing privacy settings. The current approach to privacy settings is often binary, where users have to choose between sharing their content with everyone or a select few. This can lead to users feeling uncomfortable sharing certain types of content, as they may or may not want to share it with their entire network. In some cases, users may be unaware of the types of privacy settings available to them. Moreover, the numerous privacy settings options can result in either overly restrictive or overly expansive audience selection, potentially eroding trust and safety in the platform. The present disclosure is generally directed to systems and methods for smart setting configuration that use machine learning to intelligently suggest privacy settings for users of social media platforms.

By utilizing machine learning algorithms and cross-platform information, the systems described herein may provide users with personalized privacy settings and/or other settings that adapt to their changing needs and preferences. The systems described herein may analyze user behavior, content type, and/or audience engagement to suggest ideal privacy settings for each piece of content as well as central settings. Additionally, the systems described herein may proactively suggest changes to central settings based on past learnings and user behavior. Examples of privacy settings may include, without limitation, audience settings, visibility settings, user preferences, and/or content control settings

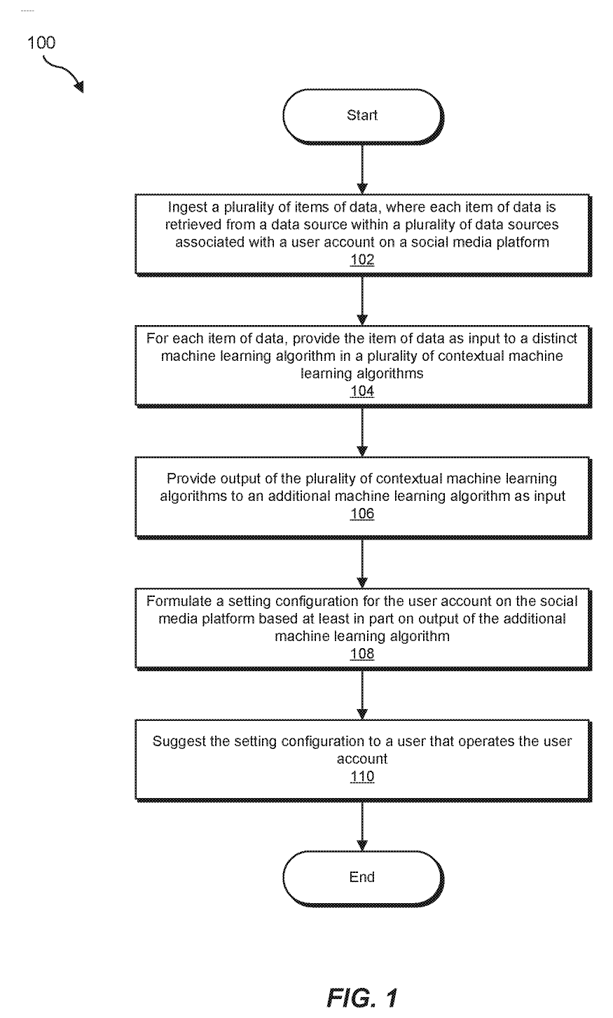

In one embodiment, as illustrated in FIG. 1, at step 102, the systems described herein may ingest a plurality of items of data, where each item of data is retrieved from a data source within a plurality of data sources associated with a user account on a social media platform. For example, the systems described herein may retrieve data on user demographics, previous user interactions with the social media platform, user interactions with linked platforms, etc.

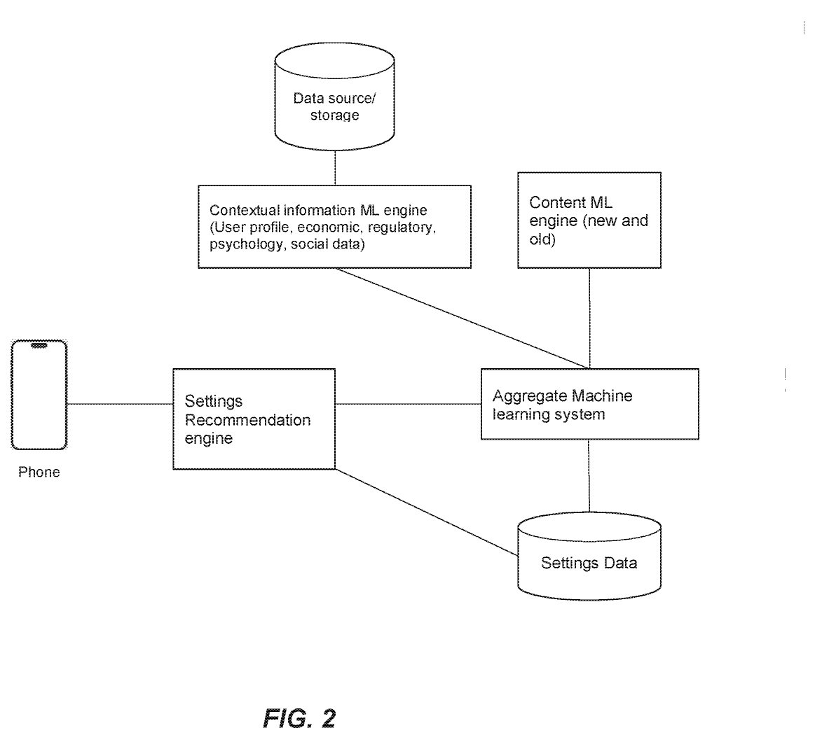

At step 104, the systems described herein may, for each item of data, provide the item of data as input to a distinct machine learning algorithm in a plurality of contextual machine learning algorithms. For example, as illustrated in FIG. 2, the systems described herein may prove demographic information to a contextual information engine and may provide information on past content posted by the user and/or content currently being composed by the user to a content analysis engine. In some embodiments, the content analysis engine and/or other algorithms may have access to data storage (e.g., one or more databases) that access and/or aggregate cross-platform data (e.g., data from user accounts on other platforms to which the user has linked their user account on the social media platform).

At step 106, the systems described herein may provide output of the plurality of contextual machine learning algorithms to an additional machine learning algorithm as input. For example, as illustrated in FIG. 2, the contextual information engine and content analysis engine may provide input to a machine learning system.

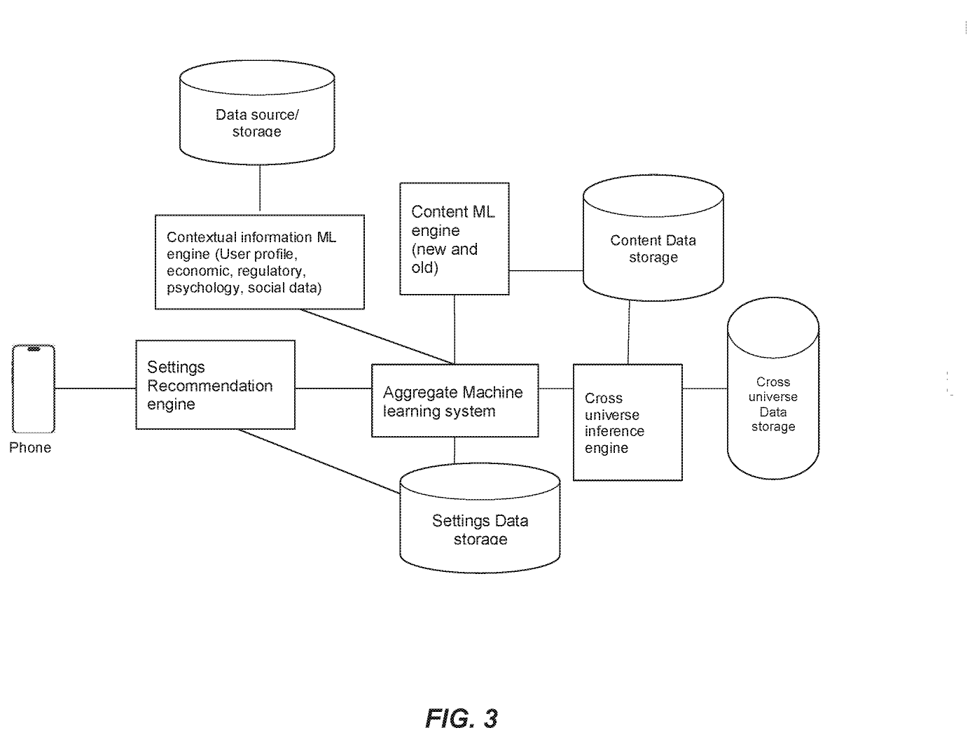

At step 108, the systems described herein may formulate a setting configuration for the user account on the social media platform based at least in part on output of the additional machine learning algorithm. For example, as illustrated in FIGS. 2 and 3, the machine learning system may add data to a settings data storage entity that may provide data to a settings recommendation engine that generates setting configurations.

At step 110, the systems described herein may suggest the setting configuration to a user that operates the user account. For example, as illustrated in FIGS. 2 and 3, the settings recommendation engine may generate a user interface event on a user’s phone. For example, the systems described herein may pre-fill form inputs with suggestions, use a wizard-style guide to make suggestions, and/or any other suitable interface.

In some embodiments, the systems described herein may classify users based on their content generation and consumption habits. In one embodiment, a scale may categorize users as regular content generators or consumers. In some examples, the systems described herein may use cross-platform information to classify users, taking into account their behavior across different social media platforms.

The systems described herein may analyze the audience settings selected by users for past content, including the number of , shares, and other engagement signals. This analysis may help the system understand what works best for each user and suggest ideal privacy settings for future content.

In some embodiments, the systems described herein may analyze the current content being generated and detect the ideal setting for that specific content. The system may take into account factors such as content type, audience engagement, applicable regulations, content engagement, user demographics, environmental information, and/or user behavior to make informed suggestions. For example, the systems described herein may suggest different settings for long text posts (e.g., close friends) than for image posts with short descriptions (e.g., wider audiences).

In some embodiments, the systems described herein may modify settings based on the information consumed by the user on the platform or platforms in place of or in addition to information generated by the user and/or shared by the user. For example, if a user is consuming information regarding specific content, the systems described herein may proactively recommend and/or change notification settings related to that content. In some examples the systems described herein may suggest value, setting type, and/or name and may change any of these things using standard configuration templates.

Based on past learnings and user behavior, the systems described herein may default the current audience setting for new content. Additionally, or alternatively, the system may suggest to the user what settings they should configure for optimal engagement and privacy. In some examples, the systems described herein may proactively suggest changes to settings based on past learnings and user behavior. For example, if a user frequently shares content with a specific group of friends, the system may suggest adding those friends to a custom list for easier sharing in the future. If a user is an influencer and content meet various signals, then the system may suggest specific settings as well as pages, groups, etc., for that content to expand the user base.

In some embodiments, the systems described herein may analyze the past several days of content posted by the user to the social media platform and/or connected platforms to detect ideal settings for each piece of content. This analysis may help the system identify patterns and trends in user behavior, allowing for more accurate suggestions.

In some examples, the systems described herein may utilize age information to ensure regulations are respected and adjust default settings accordingly. For example, if a user is under 18, the system may default to more restrictive privacy settings. Additionally, geographic location information may be used to suggest settings that are appropriate for the user's region. In some examples, different regions may have different regulations and/or cultural norms that affect a user’s sharing patterns. For example, users in a certain region may trend towards sharing political content with close groups of friends only while users in another region may trend towards sharing political content with a broader audience.

In one embodiment, the systems described herein may adjust and propose multiple tiers of settings residing in multiple locations. This may allow users to have more granular control over their privacy settings and tailor them to specific situations or audiences. For example, the systems described herein may suggest or adjust settings for general user account privacy, privacy for specific content, user notifications, and so forth.

In some examples, the systems described herein may aim to either restrict or enhance the audience based on contextual information and learnings using past data. For example, if a user frequently shares content related to a specific topic, the system may suggest expanding the audience to include users who have shown interest in that topic.

In some embodiments, the systems described herein may include a plurality of systems where multiple systems can interact with data, ML models, and/or settings across platforms to ensure a consistent user experience across multiple settings. For example, if a user chooses to share a certain type of content more publicly, the systems described herein may automatically make consistent privacy setting changes across multiple platforms. Similarly, the systems described herein may update settings across multiple platforms based on user content consumption and/or choices users make for content consumption preferences.

Further detailed examples of data sources and algorithms for ingesting data from those data sources include a number of features. For example, contextual personalization features, as described herein, can harness multiple input and contextual information that can be used to generate custom settings specific to a user without active input from the user. Inputs can include user behavior data, user preferences, and/or contextual information. Inputs can be processed to determine patterns, trends, and/or correlations. This results in an improved user experience and reduced discrepancies across system settings.

Example models for processing can include a user profile model to process user profile parameters (e.g., a multi layer perception model, etc.), a behavioral data model to process behavioral data (e.g., a decision tree model, etc.), a social network model (e.g., graph neural network, etc.) to process social network parameters, a regulatory machine learning model (e.g., a neural network model, etc.) to process regulatory parameters, a economic model (e.g., a linear regression model, etc.) to process economic parameters, and/or one or more additional models such as a random forest model, a support vector machine, a gradient boosting model, and so forth. The models can be aggregated into an ensemble model that creates an output of custom user settings. Each of these parameters is described in detail in US 63/750,382, filed January 28, 2025, which is incorporated by reference herein.

The systems described herein have numerous advantages, including personalized privacy settings that adapt to user behavior and preferences, increased user comfort and confidence in sharing content, improved engagement and reach for content creators, enhanced user experience through proactive suggestions and streamlined privacy management, compliance with regulations and respect for user privacy, more granular control over privacy settings through multiple tiers of settings, and adaptive audience settings based on contextual information and learnings.

In some aspects, the techniques described herein relate to a method including: ingesting a plurality of items of data, wherein each item of data is retrieved from a data source within a plurality of data sources associated with a user account on a social media platform; for each item of data, providing the item of data as input to a distinct machine learning algorithm in a plurality of contextual machine learning algorithms; providing output of the plurality of contextual machine learning algorithms to an additional machine learning algorithm as input; formulating a setting configuration for the user account on the social media platform based at least in part on output of the additional machine learning algorithm; and suggesting the setting configuration to a user that operates the user account.

In some aspects, the techniques described herein relate to a method, wherein suggesting the setting configuration includes suggesting a setting value.

In some aspects, the techniques described herein relate to a method, further including: receiving an indication that the user has accepted the suggested setting configuration; and automatically configuring the setting configuration in response to the indication.

In some aspects, the techniques described herein relate to a method, wherein automatically configuring the setting configuration in response to the indication includes configuring the setting configuration across a plurality of linked platforms that includes the social media platform.

In some aspects, the techniques described herein relate to a method, wherein the setting configuration includes a privacy setting for an item of content being composed by the user account to the social media platform.

In some aspects, the techniques described herein relate to a method, wherein the plurality of data sources includes data about previous items of content posted by the user account to the social media platform.

In some aspects, the techniques described herein relate to a method, wherein the plurality of data sources includes data about the item of content.

In some aspects, the techniques described herein relate to a method, wherein the plurality of data sources include data consumed by the user account on the social media platform.

In some aspects, the techniques described herein relate to a method, wherein the plurality of data sources includes data from external platforms linked to the user account on the social media platform.

In some aspects, the techniques described herein relate to a method, wherein the plurality of data sources includes demographic data about a user associated with the user account.

In some aspects, the techniques described herein relate to a method, wherein the setting configuration includes a privacy setting for the user account.

In some aspects, the techniques described herein relate to a method, wherein the setting configuration includes a notification setting for the user account.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A method comprising:
ingesting a plurality of items of data, wherein each item of data is retrieved from a data source within a plurality of data sources associated with a user account on a social media platform;
for each item of data, providing the item of data as input to a distinct machine learning algorithm in a plurality of contextual machine learning algorithms;
providing output of the plurality of contextual machine learning algorithms to an additional machine learning algorithm as input;
formulating a setting configuration for the user account on the social media platform based at least in part on output of the additional machine learning algorithm; and
generating a recommendation comprising the setting configuration to a user that operates the user account.

2. The method of claim 1, wherein suggesting the setting configuration comprises suggesting a setting value.

3. The method of claim 1, further comprising:
receiving an indication that the user has accepted the suggested setting configuration; and
automatically configuring the setting configuration in response to the indication.

4. The method of claim 3, wherein automatically configuring the setting configuration in response to the indication comprises configuring the setting configuration across a plurality of linked platforms that comprises the social media platform.

5. The method of claim 1, wherein the setting configuration comprises a privacy setting for an item of content being composed by the user account to the social media platform.

6. The method of claim 5, wherein the plurality of data sources comprises data about previous items of content posted by the user account to the social media platform.

7. The method of claim 5, wherein the plurality of data sources comprises data about the item of content.

8. The method of claim 1, wherein the plurality of data sources comprise data consumed by the user account on the social media platform.

9. The method of claim 1, wherein the plurality of data sources comprises data from external platforms linked to the user account on the social media platform.

10. The method of claim 1, wherein the plurality of data sources comprises demographic data about a user associated with the user account.

11. The method of claim 1, wherein the setting configuration comprises a privacy setting for the user account.

12. The method of claim 1, wherein the setting configuration comprises a notification setting for the user account.

13. A system comprising:
memory configured to store computer-executable instructions; and
at least one computer processor configured to access the memory and execute the computer-executable instructions to:
ingest a plurality of items of data, wherein each item of data is retrieved from a data source within a plurality of data sources associated with a user account on a social media platform;
for each item of data, provide the item of data as input to a distinct machine learning algorithm in a plurality of contextual machine learning algorithms;
provide output of the plurality of contextual machine learning algorithms to an additional machine learning algorithm as input;
formulate a setting configuration for the user account on the social media platform based at least in part on output of the additional machine learning algorithm; and
generate a recommendation comprising the setting configuration to a user that operates the user account.

14. The system of claim 13, wherein the at least one processor is further configured to access the memory and execute the computer-executable instructions to:
receive an indication that the user has accepted the suggested setting configuration; and
automatically configure the setting configuration in response to the indication.

15. The system of claim 14, wherein automatically configuring the setting configuration in response to the indication comprises configuring the setting configuration across a plurality of linked platforms that comprises the social media platform.

16. The system of claim 13, wherein the setting configuration comprises a privacy setting for an item of content being composed by the user account to the social media platform.

17. The system of claim 13, wherein the plurality of data sources comprises data about previous items of content posted by the user account to the social media platform.

18. The system of claim 13, wherein the plurality of data sources comprises data about the item of content.

19. The system of claim 13, wherein suggesting the setting configuration comprises suggesting a setting value.

20. The system of claim 13, wherein the plurality of data sources comprise data consumed by the user account on the social media platform.
